(19) United States
(12) Patent Application Publication
(10) Pub. No.: US 2011/0131293 A1
(43) Pub. Date: Jun. 2, 2011

(54) DATA DELIVERY APPARATUS AND DATA DELIVERY METHOD

(75) Inventor: Takahiro MORI, Kawasaki (JP)

(73) Assignee: FUJITSU LIMITED, Kawasaki-shi (JP)

(21) Appl. No.: 12/954,980

(22) Filed: Nov. 29, 2010

(30) Foreign Application Priority Data
Nov. 30, 2009 (JP) 2009-271129

(51) Int. Cl. G06F 15/16

(52) U.S. Cl. 709/217

(57) ABSTRACT

A data delivery apparatus includes a first obtaining section, a second obtaining section, and a delivery section. The first obtaining section obtains a master image. The master image is a first image file generated from master data used in common for constructing different systems in the plurality of information processing apparatuses. The second obtaining section obtains a difference image. The difference image is a second image file generated from difference data specifying details of modification to the master data to construct an individual system. The delivery section delivers the master image and the difference image to the plurality of information processing apparatuses over a network.

### CROSS-REFERENCE TO RELATED APPLICATION

This application is based upon and claims the benefit of priority of the prior Japanese Patent Application No. 2009-271129, filed on Nov. 30, 2009, the entire contents of which are incorporated herein by reference.

### FIELD

Embodiments discussed herein are related to a data delivery apparatus that delivers data used for system construction in an information processing apparatus.

### BACKGROUND

In an information processing apparatus such as a personal computer, an important file stored within a hard disk may sometimes be damaged. For such cases, a recovery technology has been known that uses a backup image, which is an image file of a constructed system, to restore factory setting of the information processing apparatus. A backup image is stored in a predetermined area in the hard disk or a portable recording medium such as a compact disk read-only memory (CD-ROM).

Another technology has been known that delivers an original image file over a network and constructs the system in the target information processing apparatus on the basis of the image file. For example, in order to construct the same system in a plurality of information processing apparatuses in a factory having a huge number of information processing apparatuses running, an image file for the system is delivered simultaneously to the target plurality of information processing apparatuses over a network within the factory. In each of the information processing apparatuses having received the image file, the same system is constructed on the basis of the delivered image file. Japanese Laid-open Patent Publication No. 2003-288216 discloses a related technique.

### SUMMARY

According to an aspect of the present invention, provided is a data delivery apparatus for delivering data to a plurality of information processing apparatuses. The data delivery apparatus includes a first obtaining section, a second obtaining section, and a delivery section. The first obtaining section obtains a master image. The master image is a first image file generated from master data used in common for constructing different systems in the plurality of information processing apparatuses. The second obtaining section obtains a difference image. The difference image is a second image file generated from difference data specifying details of modification to the master data to construct an individual system. The delivery section delivers the master image and the difference image to the plurality of information processing apparatuses over a network.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a data delivery system according to an embodiment of the present invention;

FIG. 2 is a diagram illustrating an exemplary functional configuration of a master computer according to an embodiment of the present invention;

FIG. 3 is a diagram illustrating an exemplary functional configuration of a data delivery apparatus according to an embodiment of the present invention;

FIG. 4 is a diagram illustrating an exemplary functional configuration of an information processing apparatus according to an embodiment of the present invention;

FIG. 5 is a diagram illustrating an exemplary operation flow of a master computer according to an embodiment of the present invention;

FIG. 6 is a diagram illustrating a relationship between a master image and a difference image in a data delivery system according to an embodiment of the present invention;

FIG. 7 is a diagram illustrating an exemplary operation flow of a data delivery apparatus according to an embodiment of the present invention;

FIG. 8 is a diagram illustrating an exemplary correspondence table in a data delivery apparatus according to an embodiment of the present invention;

FIG. 9 is a diagram illustrating transmission of a correspondence table and deployment program in a data delivery system according to an embodiment of the present invention;

FIG. 10 is a diagram illustrating an exemplary operation flow of an information processing apparatus according to an embodiment of the present invention;

FIG. 11 is a diagram illustrating construction of a system in an information processing apparatus according to an embodiment of the present invention;

FIG. 12 is a diagram illustrating construction of a system in an information processing apparatus according to an embodiment of the present invention;

FIG. 13 is a diagram illustrating processing from generation of an image set to construction of a system in a data delivery system according to an embodiment of the present invention;

FIG. 14 is a diagram illustrating processing from generation of an image file for each system to construction of a system through deployment of the generated image file; and

FIG. 15 is a diagram illustrating appearance of a data delivery apparatus according to an embodiment of the present invention.

### DESCRIPTION OF EMBODIMENTS

In constructing systems in a plurality of information processing apparatuses, the systems to be constructed may vary from one information processing apparatus to another because of differences between hardware configurations of the information processing apparatuses or differences between application programs to be installed. In this case, image files are prepared for the different systems. This however may increase worker's time and effort and increase the load on the apparatus that generates the image files and thus take a large amount of time to construct the systems in all information processing apparatuses. The apparatus that delivers the image files may be required to have a large memory capacity for storing the plurality of different image files.

Accordingly, it is preferable to provide a data delivery apparatus that may efficiently deliver data used for system construction in information processing apparatuses.

With a data delivery apparatus according to embodiments of the present invention, data used for system construction in information processing apparatuses may be efficiently delivered.

Embodiments of the present invention will be discussed with reference to drawings.

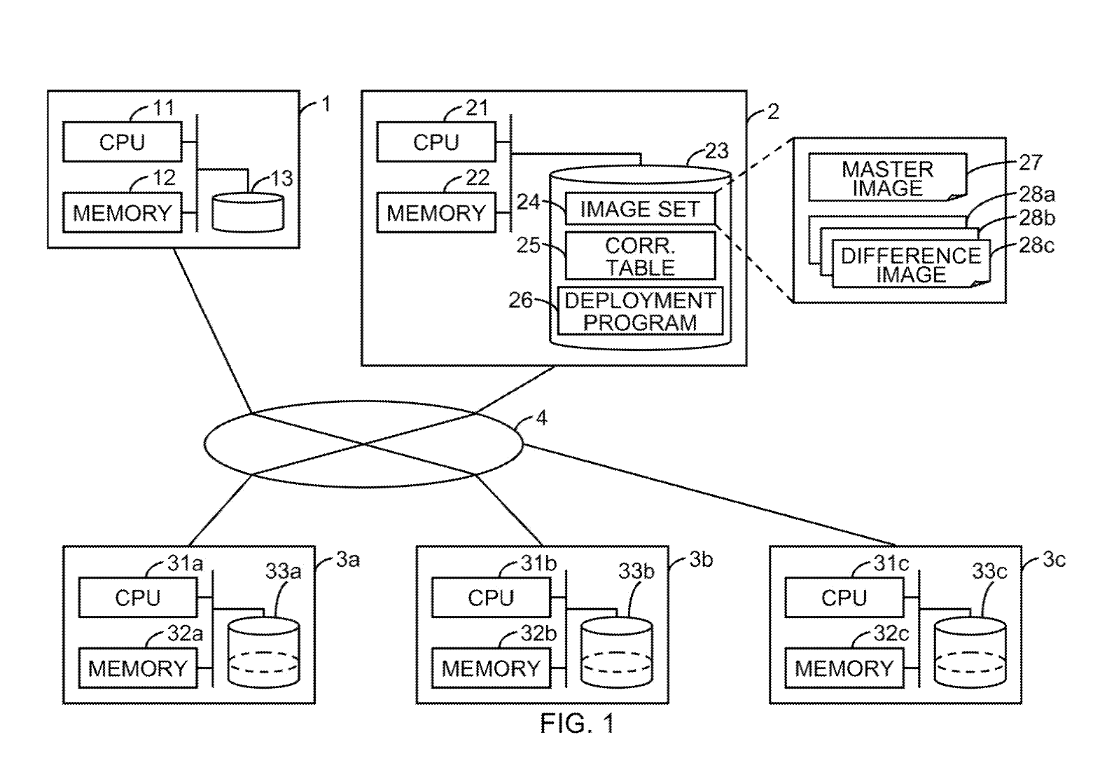

A configuration of a data delivery system according to an embodiment of the present invention will be discussed. FIG. 1 illustrates an exemplary configuration of a data delivery system according to the present embodiment. As illustrated in FIG. 1, the data delivery system includes a master computer 1, a data delivery apparatus 2, and information processing apparatuses 3a, 3b, and 3c. These components are connected via a network 4 such as the Internet.

The master computer 1 includes a central processing unit (CPU) 11 that is responsible for control over the entire computer, a memory 12 that stores data and/or a program, and a hard disk drive (HDD) 13 that stores an operating system (OS) and/or other application programs. The CPU 11 may transmit data to the data delivery apparatus 2 and receive data from the network 4 via a transmission/reception interface (not illustrated). The memory 12 may be volatile.

The data delivery apparatus 2 is a deployment server for constructing a system. The data delivery apparatus 2 includes a CPU 21 that is responsible for control over the entire data delivery apparatus 2, a memory 22 that stores data and/or a program, and an HDD 23 that stores an OS and/or other application programs. The CPU 21 may transmit data to the information processing apparatuses 3a, 3b, and 3c and receive data from the master computer 1 through a transmission/reception interface (not illustrated). The memory 22 may be volatile. The HDD 23 stores an image set 24, a correspondence table (also denoted by “CORR. TABLE” in the drawings) 25 and a deployment program 26, which will be discussed below. The image set 24 includes a master image 27 and difference images 28 (28a, 28b, and 28c).

The information processing apparatuses 3a, 3b, and 3c are target computers in which systems are to be constructed. The information processing apparatus 3a includes a CPU 31a that is responsible for control over the entire information processing apparatus 3a, a memory 32a that stores data and/or a program, and an HDD 33a that stores an OS and/or other application programs. The CPU 31a may transmit data to a network and receive data from the data delivery apparatus 2 through a transmission/reception interface (not illustrated). The memory 32a may be volatile. The HDD 33a preserves a predefined “reserved area”. The “reserved area” is a memory area that the CPU 31a is not caused to access by the OS. The information processing apparatuses 3b and 3c include CPUs 31b and 31c, memories 32b and 32c, and HDDs 33b and 33c, respectively. Since these components are similar to those in the information processing apparatus 3a, the detailed discussions will be omitted. According to the present embodiment, different systems are to be constructed in the information processing apparatuses 3a, 3b, and 3c. However, the number of information processing apparatuses and the number of types of system to be constructed are not limited thereto.

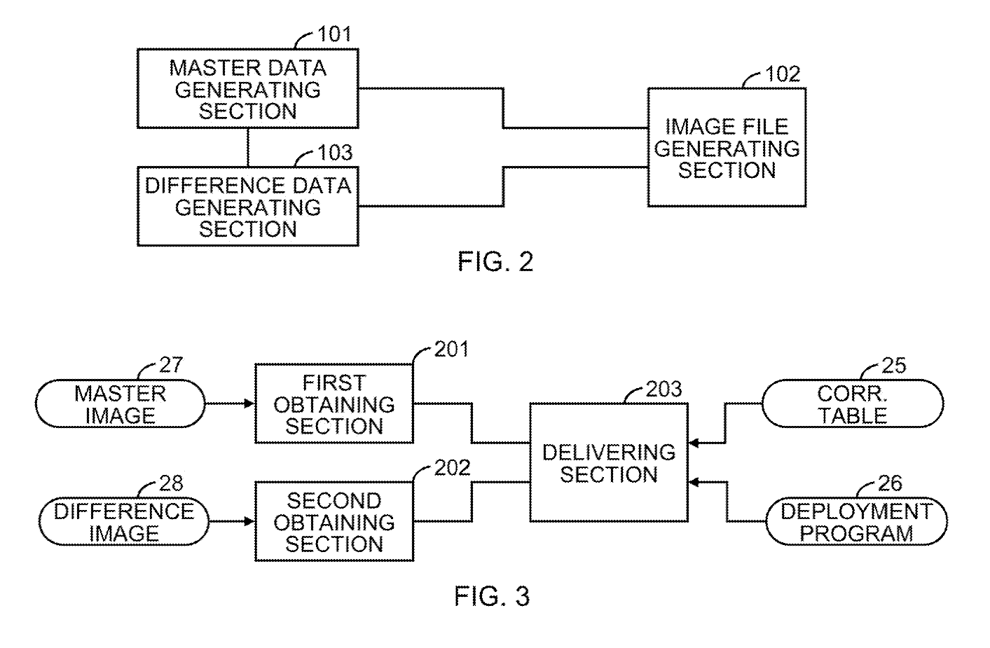

FIG. 2 illustrates an exemplary functional configuration of the master computer 1 according to the present embodiment. With reference to FIG. 2, functions of the master computer 1 will be discussed. The master computer 1 includes a master data generating section 101, an image file generating section 102, and a difference data generating section 103. The master data generating section 101 generates master data. The master data is data to be used for system construction in the information processing apparatuses 3a, 3b, and 3c and is commonly used in the information processing apparatuses 3a, 3b, and 3c. In other words, the master data is used as a base for system construction in a plurality of information processing apparatus. The image file generating section 102 converts master data generated by the master data generating section 101 to an image file to generate a master image 27. In order to generate a master image 27, the master data itself stored in the HDD 13 is converted to the image file.

The difference data generating section 103 generates difference data. The difference data specifies details of modification added to the master data to construct a specific system. For example, in order to modify the master data to construct a system in the information processing apparatus 3a, the difference data generating section 103 generates the difference data specifying details of the modification. The image file generating section 102 converts the difference data generated by the difference data generating section 103 to an image file to generate a difference image 28. The image file generating section 102 transmits the generated master image 27 and difference image 28 to the data delivery apparatus 2.

The functions of the master computer 1 may be implemented by collaboration of the CPU 11, memory 12, and HDD 13. The system to be constructed in an information processing apparatus is determined on the basis of at least one of a device driver to be built in the information processing apparatus, an application program to be installed in the information processing apparatus, and an OS to be executed by the information processing apparatus.

FIG. 3 illustrates an exemplary functional configuration of the data delivery apparatus 2 according to the present embodiment. With reference to FIG. 3, functions of the data delivery apparatus 2 will be discussed. The data delivery apparatus 2 includes a first obtaining section 201, a second obtaining section 202, and a delivering section 203. The first obtaining section 201 obtains the master image 27 from the master computer 1. The first obtaining section 201 transmits the obtained master image 27 to the delivering section 203. The second obtaining section 202 obtains a difference image 28 form the master computer 1. The second obtaining section 202 transmits the obtained difference image 28 to the delivering section 203.

The delivering section 203 simultaneously delivers the master image 27 obtained by the first obtaining section 201 and the difference image 28 obtained by the second obtaining section 202 to the information processing apparatuses 3a, 3b, and 3c. In the simultaneous delivery, the delivering section 203 combines the master image 27 and the difference image 28 to generate the image set 24. The delivering section 203 simultaneously delivers the image set 24 to the information processing apparatuses 3a, 3b, and 3c.

Before the simultaneous delivery of the image set 24, the delivering section 203 delivers a correspondence table 25 and a deployment program 26 stored in the HDD 23 to the information processing apparatuses 3a, 3b, and 3c. The correspondence table 25 is data which specifies the systems to be constructed in the target information processing apparatuses. The deployment program 26 is a program executable by any of the target information processing apparatuses 3a, 3b, and 3c. The functions of the data delivery apparatus 2 may be implemented by collaboration of the CPU 21, memory 22, and HDD 23.

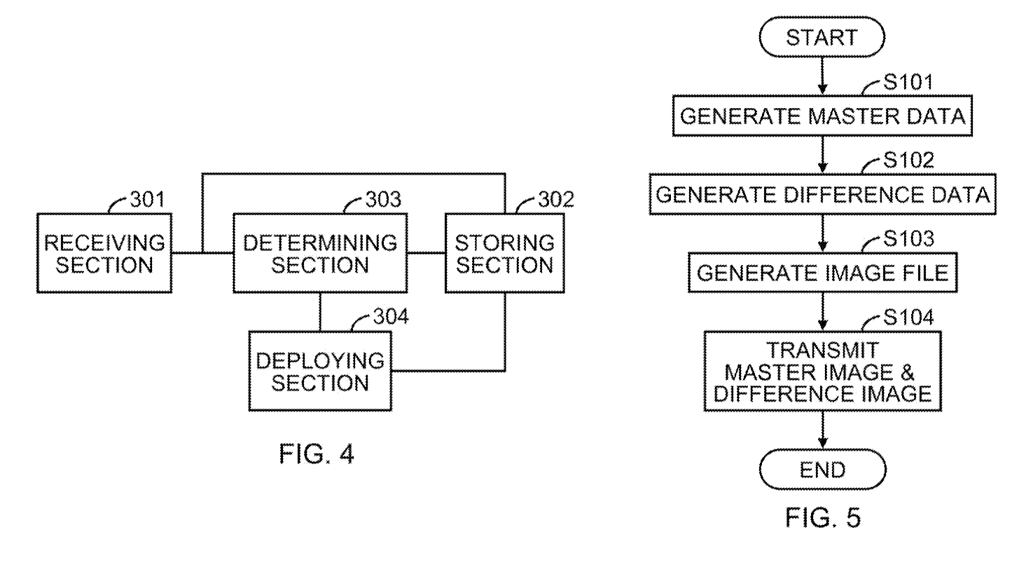

FIG. 4 illustrates an exemplary functional configuration of the information processing apparatus 3a according to the present embodiment. With reference to FIG. 4, functions of the information processing apparatus 3a will be discussed. The information processing apparatus 3a includes a receiving section 301, a storing section 302, a determining section 303, and a deploying section 304. The receiving section 301 receives the master image 27 and difference image 28 from the data delivery apparatus 2 over the Internet 4. Before receiving the master image 27 and difference image 28, the receiving section 301 receives the correspondence table 25 which specifies the system to be constructed in the information processing apparatus 3a and the deployment program 26 executable by the information processing apparatus 3a.

The receiving section 301 transmits the correspondence table 25 and deployment program 26 to the storing section 302. The storing section 302 stores the correspondence table 25 and deployment program 26 in the HDD 33a. The receiving section 301 notifies the determining section 303 of the reception of the master image 27 and difference image 28.

The determining section 303 determines whether the difference image received by the receiving section 301 is necessary for the system to be constructed in the information processing apparatus 3a. More specifically, the determining section 303 refers to the correspondence table 25 stored in the HDD 33a by the storing section 302. With reference to the data on the correspondence table 25, the determining section 303 determines whether the received difference image is necessary for constructing the system in the information processing apparatus 3a. The determining section 303 notifies the storing section 302 of the difference image 28 determined as necessary. The storing section 302 stores the master image 27 and the difference image 28 determined as necessary in the reserved area of the HDD 33a.

The deploying section 304 deploys the master image 27 and the difference image 28 determined as necessary on the basis of the deployment program 26 stored in the HDD 33a. The deployment of the master image 27 and the difference image 28 determined as necessary allows construction of the system specified by the correspondence table 25 in the information processing apparatus 3a.

The functions of the above discussed information processing apparatus 3a may be implemented by collaboration of the CPU 31a, memory 32a, and HDD 33a. The information processing apparatuses 3b and 3c have functions similar to those of the information processing apparatus 3a. The discussions on the functions of the information processing apparatuses 3b and 3c will be omitted.

FIG. 5 illustrates an exemplary operation flow of the master computer 1 according to the present embodiment. With reference to FIG. 5, the operation flow of the master computer 1 will be discussed.

In operation S101, the CPU 11 generates master data in accordance with the instruction from an operator. The master data is data used for system construction and is commonly used for constructing systems in the information processing apparatuses 3a, 3b, and 3c. The master data is generated on the basis of at least one of a device driver commonly built in the information processing apparatuses 3a, 3b, and 3c, an application program commonly installed in the information processing apparatuses 3a, 3b, and 3c, and the OS that is commonly executed by the information processing apparatuses 3a, 3b, and 3c.

In operation S102, after generating the master data, the CPU 11 generates the difference data. According to the present embodiment, different systems are constructed in the information processing apparatuses 3a, 3b, and 3c. Thus, the CPU 11 temporarily constructs separate systems for the information processing apparatuses 3a, 3b, and 3c. The CPU 11 generates the difference data on the basis of the temporarily constructed system.

In operation S103, the CPU 11 converts the master data and difference data generated in operations S101 and S102 to image files to generate the master image 27 and difference image 28.

In operation S104, the CPU 11 transmits the generated master image 27 and difference image 28 to the data delivery apparatus 2.

By performing those operations, generation and transmission of the master image 27 and difference image 28 completes.

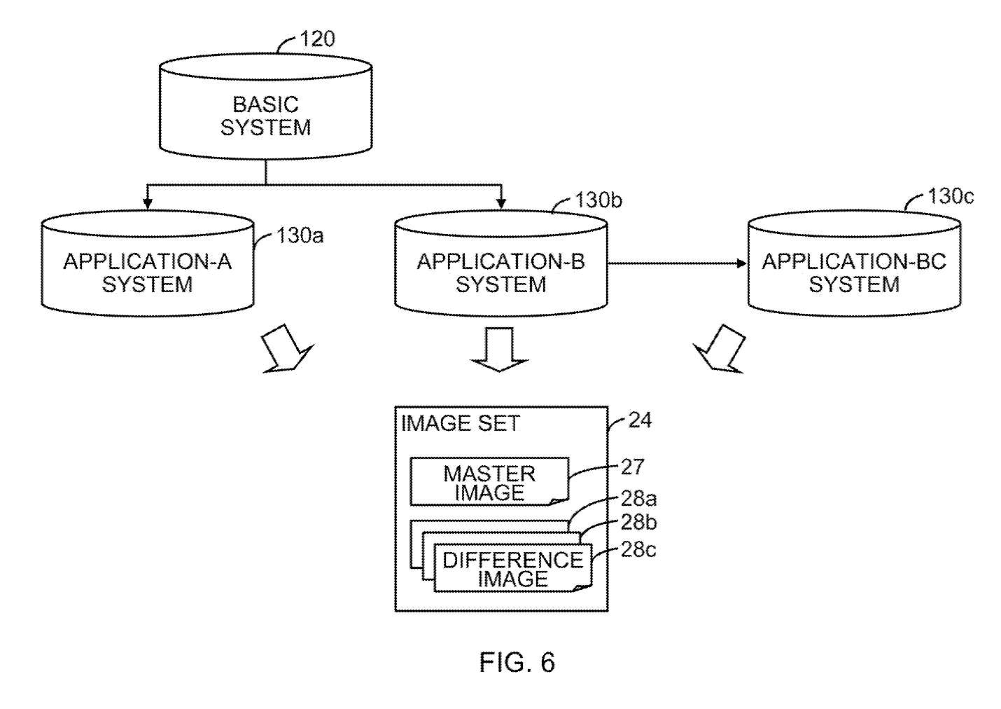

FIG. 6 illustrates a relationship between the master image 27 and the difference image 28 in the data delivery system according to the present embodiment. With reference to FIG. 6, the relationship between the master image 27 and the difference image 28 will be discussed. A basic system 120 is to be constructed on the basis of the master data only. As discussed above, according to the present embodiment, different systems are to be constructed in the information processing apparatuses 3a, 3b, and 3c. In the information processing apparatus 3a, a system containing an application program A is to be constructed. An application-A system 130a for the information processing apparatus 3a is to be constructed on the basis of the basic system 120. The data describing the difference between the basic system 120 and the application-A system 130a is the difference data for the information processing apparatus 3a. The difference data is converted to an image file to generate the difference image 28a.

In the information processing apparatus 3b, a system containing an application program B is to be constructed. An application-B system 130b for the information processing apparatus 3b is constructed on the basis of the basic system 120. The data describing the difference between the basic system 120 and the application-B system 130b is the difference data for the information processing apparatus 3b. The difference data is converted to an image file to generate the difference image 28b.

In the information processing apparatus 3c, a system containing the application program B and an application program C is to be constructed. An application-BC system 130c for the information processing apparatus 3c is constructed on the basis of the application-B system 130b for the information processing apparatus 3b. The data describing the difference between the application-B system 130b and the application-BC system 130c is the difference data for the information processing apparatus 3c. The difference data is converted to an image file to generate the difference image 28c.

As illustrated in FIG. 6, the image set 24, which will be discussed below, contains the master image 27 and difference images 28a, 28b, and 28c.

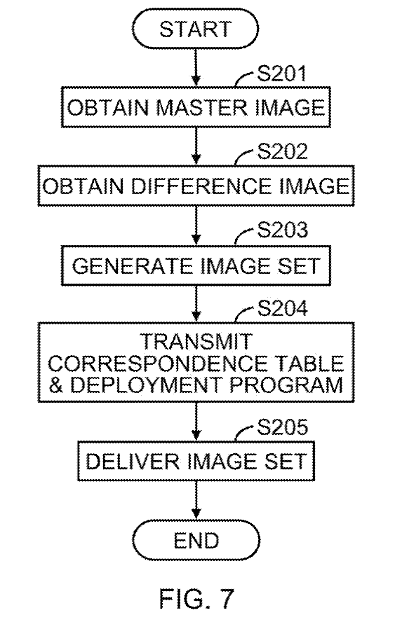

FIG. 7 illustrates an exemplary operation flow of the data delivery apparatus 2 according to the present embodiment. With reference to FIG. 7, the operation flow of the data delivery apparatus 2 will be discussed. The data delivery apparatus 2 starts operations upon receiving an instruction from an operator of the data delivery apparatus 2, upon receiving a notification, conveying that generation of the master image 27 and difference image 28 has been completed, from the master computer 1, or upon receiving the master image 27 and difference image 28 themselves.

In operation S201, the CPU 21 obtains the master image 27 from the master computer 1 over the network 4.

In operation S202, the CPU 21 obtains the difference image 28 from the master computer 1 over the network 4. The CPU 21 may perform the operation S202 earlier than operation S201. Alternatively, the CPU 21 may perform operation S201 and operation S202 at the same time. In other words, the CPU 21 may obtain the master image 27 and the difference image 28 at the same time. The difference image 28 includes the difference image 28a for the application-A system to be constructed in the information processing apparatus 3a, the difference data 28b for the application-B system to be constructed in the information processing apparatus 3b, and the difference data 28c for the application-BC system to be constructed in the information processing apparatus 3c.

In operation S203, the CPU 21 generates the image set 24 from the obtained master image 27 and difference image 28 (28a, 28b, and 28c). As illustrated in FIG. 6, the image set 24 includes the master image 27 and difference image 28 (28a, 28b, and 28c).

In operation S204, after generating the image set 24, the CPU 21 transmits the correspondence table 25 and deployment program 26 to the information processing apparatuses 3a, 3b, and 3c. As discussed above, the correspondence table 25 is data which specifies the systems to be constructed in the target information processing apparatuses. The deployment program 26 is executable by any of the target information processing apparatuses 3a, 3b, and 3c.

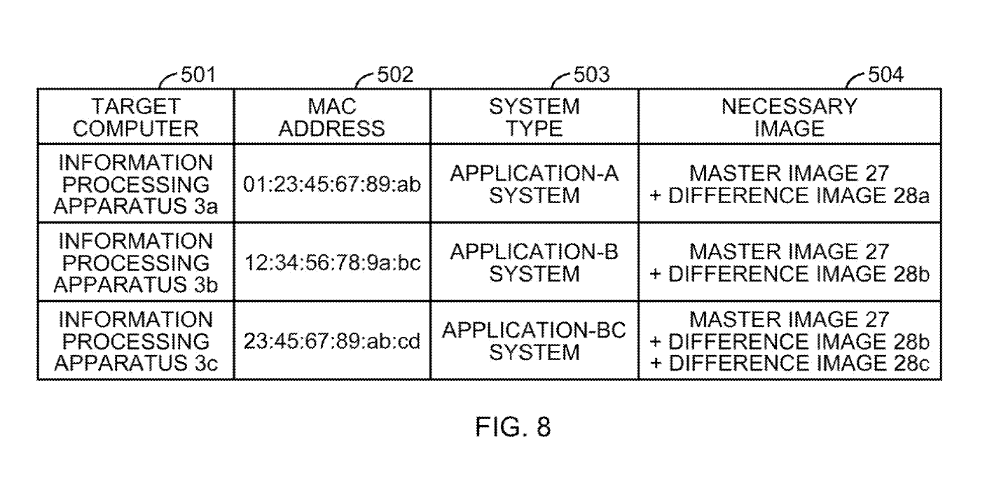

FIG. 8 illustrates an example of the correspondence table 25 in the data delivery apparatus according to the present embodiment. On the correspondence table 25, a media access control (MAC) address 502, a system type 503, and necessary image for system construction are specified for each of target computers 501, i.e., the information processing apparatuses 3a, 3b, and 3c. The MAC address 502 may be used as an identifier (ID) for identifying one of the information processing apparatuses 3a, 3b, and 3c. The system type 503 corresponds to each of the systems illustrated in FIG. 6.

More specifically, in the information processing apparatus 3a identified by MAC address (01:23:45:67:89:ab), the application-A system is to be constructed. The necessary images for constructing the application-A system may be the master image 27 and the difference image 28a. In the information processing apparatus 3b identified by MAC address (12:34:56:78:9a:bc), the application-B system is to be constructed. The necessary images for constructing the application-B system may be the master image 27 and difference image 28b. In the information processing apparatus 3c identified by MAC address (23:45:67:89:ab:cd), the application-BC system is to be constructed. The necessary images for constructing the application-BC system may be the master image 27 and difference images 28b and 28c. The data for identifying the information processing apparatuses 3a, 3b, and 3c may be model names or serial numbers of the information processing apparatuses 3a, 3b, and 3c instead of the MAC addresses.

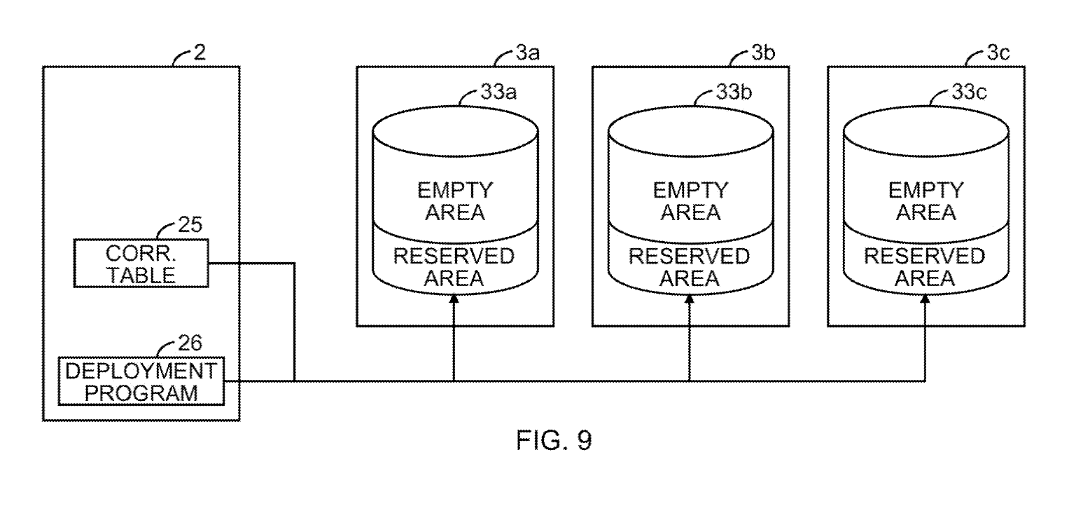

FIG. 9 illustrates transmission of the correspondence table 25 and deployment program 26 from the data delivery apparatus 2 to the information processing apparatuses 3a, 3b, and 3c in the data delivery system according to the present embodiment.

In operation S205 in FIG. 7, after transmitting the correspondence table 25 and deployment program 26, the CPU 21 simultaneously delivers the image set. The simultaneous delivery may be implemented by a multicast technology. After the completion of the simultaneous delivery, the CPU 21 notifies the information processing apparatuses 3a, 3b, and 3c that delivery of the image set 24 has been completed. Thus, transmission of the correspondence table 25 and deployment program 26 as well as simultaneous delivery of the image set has been completed.

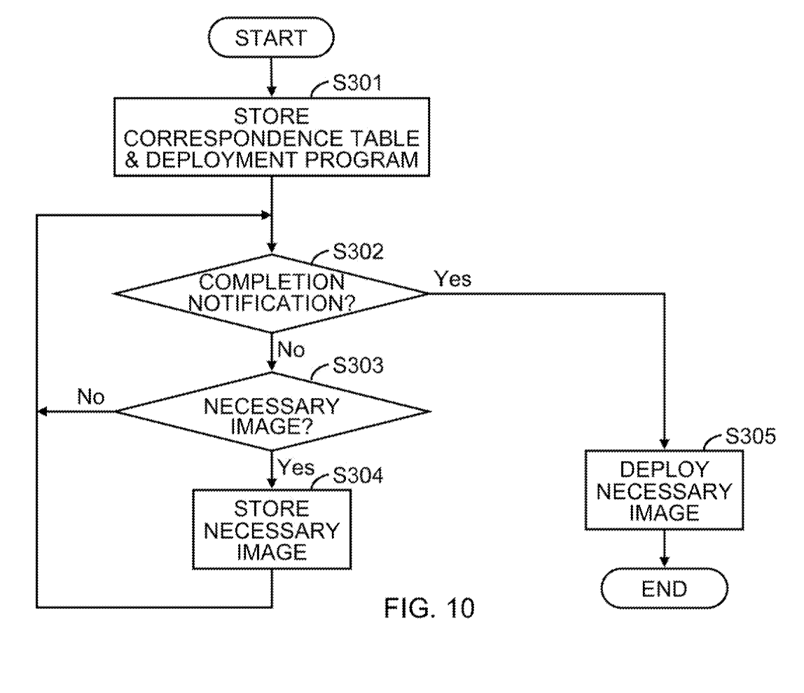

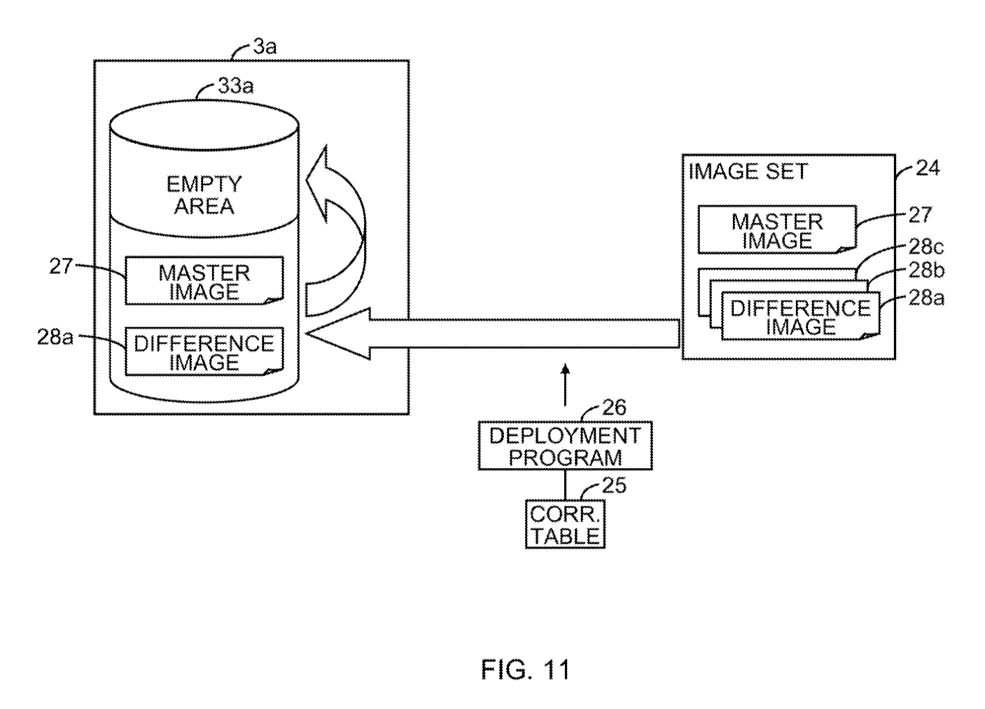

FIG. 10 illustrates an exemplary operation flow of the information processing apparatus 3a according to the present embodiment. With reference to FIG. 10, the operation flow of the information processing apparatus 3a will be discussed. The information processing apparatus 3a starts operations upon receiving an instruction from an operator of the information processing apparatus 3a or upon receiving a notification, conveying that the delivery will start, from the data delivery apparatus 2. FIG. 11 illustrates the construction of the application-A system in the information processing apparatus 3a according to the present embodiment.

In operation S301, upon receiving the correspondence table 25 and deployment program 26 over the network 4, the CPU 31a stores them in the HDD 33a.

In operation S302, after storing the correspondence table 25 and deployment program 26, the CPU 31a determines whether the CPU 31a has been notified that delivery of the image set 24 has been completed.

In operation S303, when the CPU 31a has not been notified that delivery of the image set 24 has been completed (“No” in operation S302), the CPU 31a receives a image file included in the image set 24 and determines, with reference to the correspondence table 25, whether the received image file is an image file necessary for constructing the system. When the received image file is not an image file necessary for constructing the system (“No” in operation S303), the information processing apparatus 3a returns the process to operation S302.

In operation S304, when the received image file is an image file necessary for constructing the system (“Yes” in operation S303), the CPU 31a stores the image file in the HDD 33a. Thereafter, the information processing apparatus 3a returns the process to operation S302. As discussed above, the application-A system is to be constructed in the information processing apparatus 3a. The images necessary for constructing the application-A system are the master image 27 and difference image 28a. Thus, the CPU 31a stores only the master image 27 and difference image 28a in the HDD 33a, among the image files included in the image set 24. The CPU 31a continues the operations of storing only the image files necessary for constructing the system, until the CPU 31a receives the notification that delivery of the image set 24 has been completed.

In operation S305, when the CPU 31a has been notified that delivery of the image set 24 has been completed (“Yes” in operation S302), the CPU 31a deploys the master image 27 and difference image 28a stored in the reserved area to an empty area of the HDD 33a. Thus, the application-A system is constructed in the information processing apparatus 3a.

Having discussed the operations performed by the information processing apparatus 3a, similar operations are performed in the information processing apparatuses 3b and 3c. In the information processing apparatus 3b, by performing similar operations, the master image 27 and difference image 28b are deployed, and the application-B system is constructed. In the information processing apparatus 3c, the master image 27 and difference images 28b and 28c are deployed, and the application-BC system is constructed.

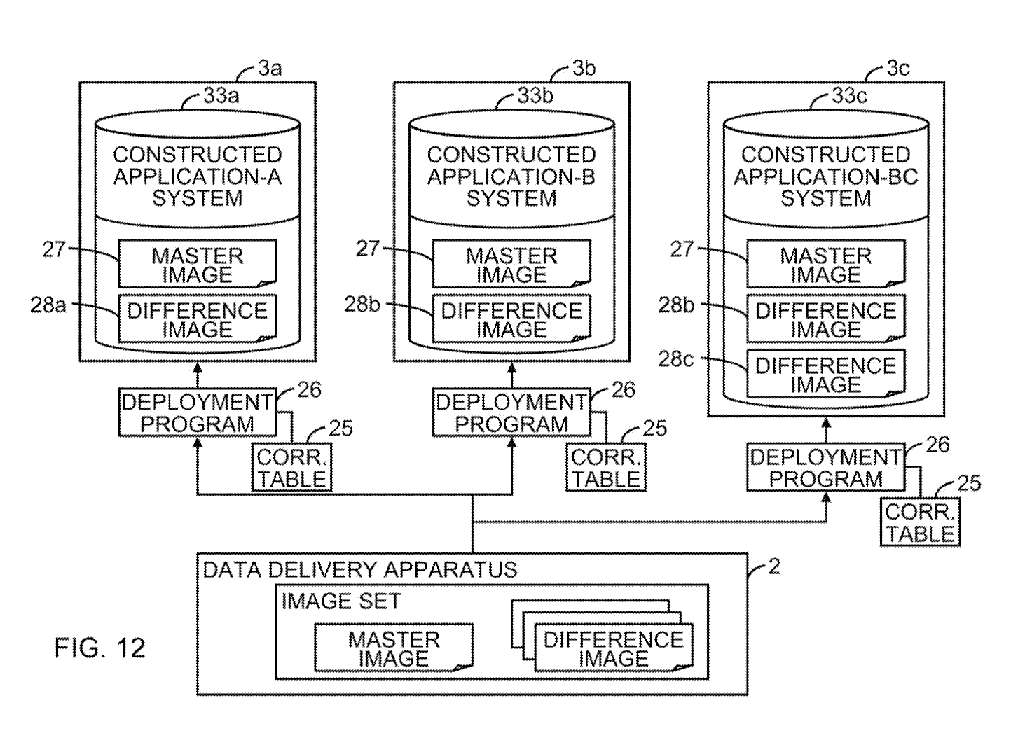

The operation flow above allows simultaneous delivery of one image set 24 and construction of different systems in the target information processing apparatuses. FIG. 12 illustrates construction of systems in the information processing apparatuses 3a, 3b, and 3c according to the present embodiment. The application-A system is constructed in the information processing apparatus 3a. The application-B system is constructed in the information processing apparatus 3b. The application-BC system is constructed in the information processing apparatus 3c.

The master image 27 and difference image 28 stored in the HDDs 33a, 33b, and 33c may be kept stored after the deployment. In that case, the stored image files may be used for recovery from unexpected data damage occurring while the information processing apparatus is running.

The deployment may not be performed after the CPU 31 has been notified that delivery of the image set 24 has been completed. For example, the deployment may be started when it is determined, with reference to the correspondence table 25, that all of the image files necessary for constructing the corresponding system have been received. Alternatively, the deployment may be performed before the image files are stored in the HDD 33. In that case, the image files may be deployed to the empty area of the HDD 33 without being stored in the reserved area.

At least one of the correspondence table 25 and deployment program 26 may be prestored in the information processing apparatuses 3a, 3b, and 3c. For example, when the deployment program 26 has been prestored in the information processing apparatuses 3a, 3b, and 3c, the data delivery apparatus 2 may transmit only the correspondence table 25 to the information processing apparatuses 3a, 3b, and 3c before simultaneously delivering the image set 24.

According to the present embodiment, one master computer 1 generates the master image 27 and difference images 28a, 28b, and 28c. However, different computers may generate image files in accordance with the types of system to be constructed.

According to the present embodiment, the master computer 1 and the data delivery apparatus 2 are connected each other over the network 4. Without limiting to the configuration, the master computer 1 and the data delivery apparatus 2 may be connected each other via a special line or a bus for external connection, for example. Alternatively, a computer having the functions of both master computer 1 and data delivery apparatus 2 may be connected to the network 4.

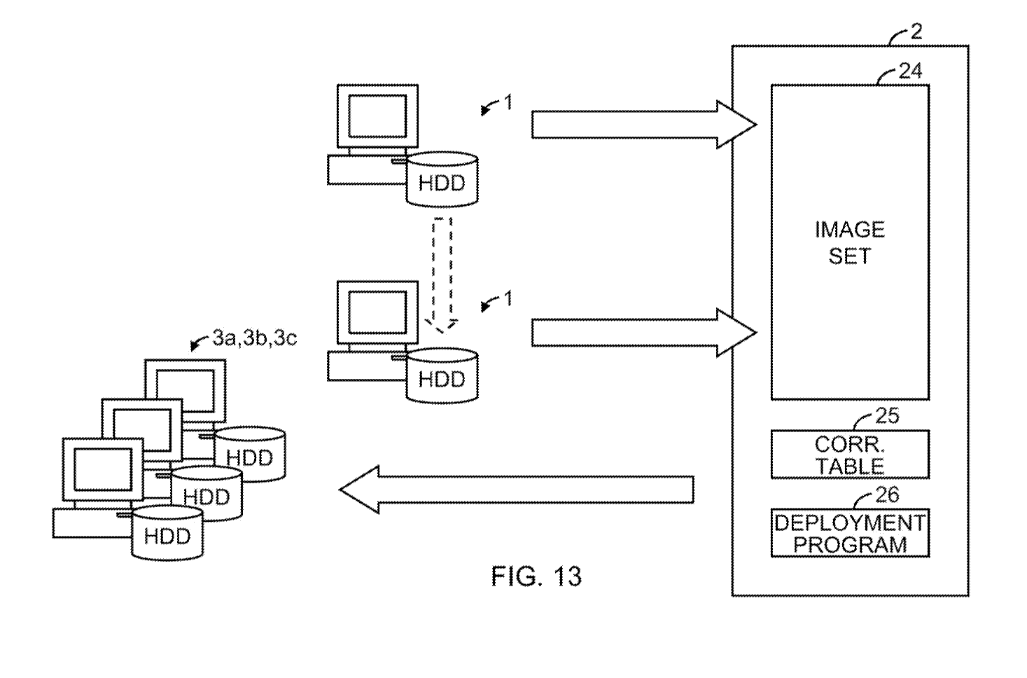

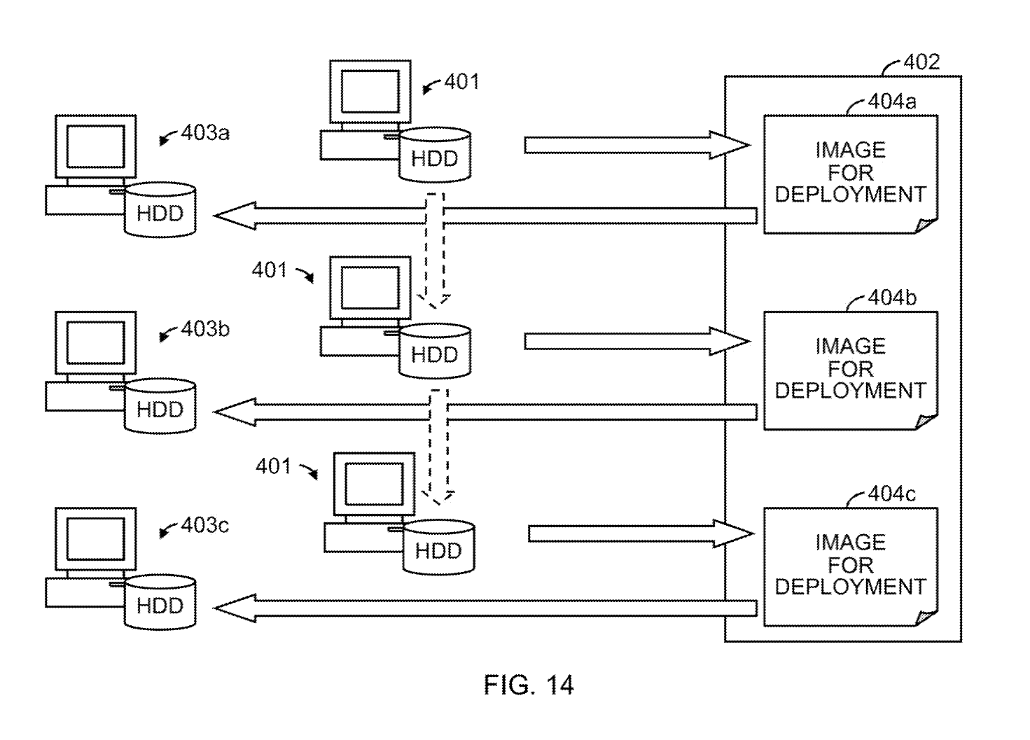

In the following discussion, the delivery and deployment using the image set will be compared, with reference to FIGS. 13 and 14, to the delivery and deployment by generating an image file for each of the different systems. FIG. 13 illustrates processing from generation of the image set to construction of the system in the data delivery system according to the present embodiment. FIG. 14 illustrates processing from generation of the image file for each system to construction of the system through deployment of the generated image file.

Referring to FIG. 14, in the information processing apparatuses 403a, 403b, and 403c, different systems are constructed. A master computer 401 generates a master image for each of the systems. A server 402 holds the plurality of master images generated for the information processing apparatuses 403a, 403b, and 403c as images 404a, 404b, and 404c for deployment. The server 402 delivers the image 404a for deployment to the information processing apparatus 403a, the image 404b for deployment to the information processing apparatus 403b and the image 404c for deployment to the information processing apparatus 403c.

Referring to FIG. 14, the number of generated images for deployment is equal to the number of types of system to be constructed. The generated images for deployment are stored in a storage device in the server 402. Referring to FIG. 13, the master image is generated which is to be commonly used for a plurality of systems to be constructed. The difference images are generated for the corresponding systems. The storage device storing the master image and the difference images may require less memory capacity than the storage device storing the images for deployment of the number equal to the number of types of system to be constructed. That is, the data delivery apparatus 2 may require less memory capacity than the server 402. The workload, generation time, and generation cost required for the master computer 1 and data delivery apparatus 2 may be less than those required for the master computer 401 and server 402. The simultaneous delivery of the image set 24 may save the network band more than the delivery of the images 404a, 404b, and 404c for deployment.

Still other embodiments may be found in various forms without departing from the spirit and scope of the present invention. The aforementioned embodiments are only examples in all points and should not be interpreted limitedly.

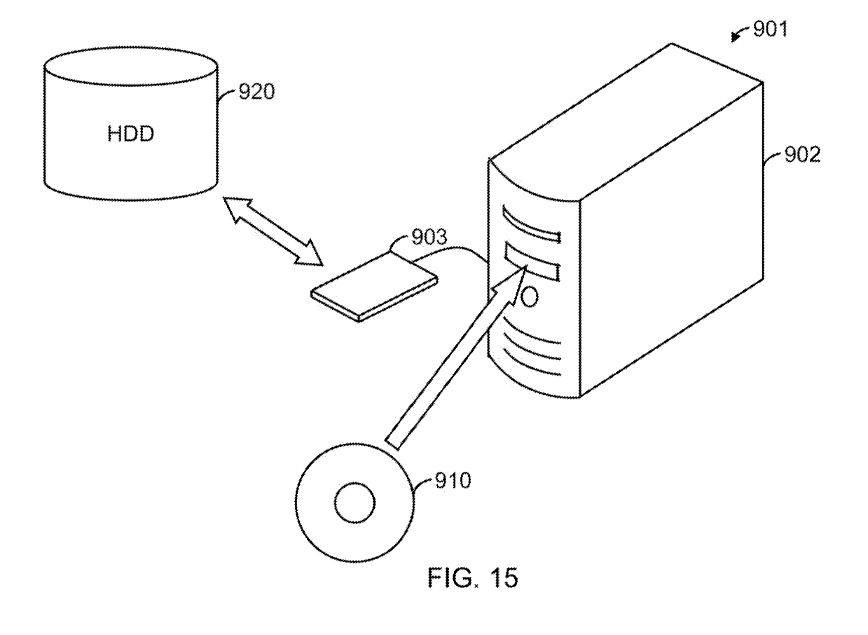

FIG. 15 illustrates an exemplary external view of the data delivery apparatus 2 according to an embodiment of the present invention. In FIG. 15, the data delivery apparatus 2 is implemented by a server 901. The CPU 21 and HDD 23 are accommodated in a housing 902. The server 901 includes a communication apparatus 903 connectable to a network such as the Internet. The communication apparatus 903 may access a database stored in an HDD 920, for example, to download programs stored in other computer systems. The communication apparatus 903 may be a network communication card or a modem. The server 901 includes a disk drive that reads and writes data from and to a portable recording medium such as a disk medium 910. The disk medium 91 includes a flexible disk, a hard disk, a CD-ROM, a digital versatile disc (DVD), and a magneto-optical disk.

A program that causes a computer to execute operations of the data delivery apparatus 2 may be provided as a data delivery program. The program may be stored in a non-transitory computer-readable recording medium and be executed by the server 901. The program that causes a computer to execute the aforementioned operations may be stored in a portable recording medium such as the disk medium 910 or may be downloaded from a recording medium in another computer through a communication apparatus. The data delivery program (data delivery software) that provides the data delivery function to a computer may be input to and compiled in the computer. The program causes the computer to operate as an information processing apparatus having an authentication control function. The program may be stored in a non-transitory computer-readable recording medium such as the disk medium 910. The non-transitory computer-readable recording medium includes an internal storage device such as a read only memory (ROM) and a random access memory (RAM) that is internally mounted in a computer, a portable recording medium such as the disk medium 910 and an integrated circuit (IC) card. The non-transitory computer-readable recording medium may be a database apparatus that holds a computer program, another computer system and a database apparatus thereof, and any recording medium connected to the computer through communication means such as a communication apparatus and accessible by the computer. The deployment program may be stored in a non-transitory computer-readable recording medium to be executed in the information processing apparatus. The non-transitory computer-readable recording medium is the same as those for the data delivery program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data delivery apparatus for delivering data to a plurality of information processing apparatuses, the data delivery apparatus comprising:
a first obtaining section configured to obtain a master image, the master image being a first image file generated from master data used in common for constructing different systems in the plurality of information processing apparatuses;
a second obtaining section configured to obtain a difference image, the difference image being a second image file generated from difference data specifying details of modification to the master data to construct an individual system; and
a delivery section configured to deliver the master image and the difference image to the plurality of information processing apparatuses over a network.

2. The data delivery apparatus according to claim 1, further comprising:
a first generating section configured to generate the master image by converting the master data to the first image file, the master data being stored in a storing section of an information processing apparatus other than the plurality of information processing apparatuses; and
a second generating section configured to generate the difference image by converting the difference data to the second image file, the difference data being generated from the master data and modified master data, the modified master data being generated by modifying the master data to construct the individual system.

3. The data delivery apparatus according to claim 1, further comprising:
a storing section configured to store a deployment program executable by each of the plurality of information processing apparatuses, wherein
the delivery section delivers the deployment program to the plurality of information processing apparatuses over the network before delivering the master image and the difference image, and
the deployment program is executed by a delivery destination apparatus and causes the delivery destination apparatus to determine whether the difference image is necessary for the delivery destination apparatus to construct the individual system, the delivery destination apparatus being one of the plurality of information processing apparatuses.

4. The data delivery apparatus according to claim 3, wherein
the delivery section delivers system specification data to the plurality of information processing apparatuses over the network before delivering the master image and the difference image, the system specification data specifying the individual system to be constructed in the delivery destination apparatus, and
the deployment program causes the delivery destination apparatus to make the determination based on the system specification data.

5. The data delivery apparatus according to claim 3, wherein
the deployment program causes the delivery destination apparatus to deploy the master image and the necessary difference image to construct the individual system in the delivery destination apparatus.

6. The data delivery apparatus according to claim 3, wherein
the deployment program causes the delivery destination apparatus to store the master image and the necessary difference image in an unused memory area of the delivery destination apparatus, the unused memory area being a memory area that the delivery destination apparatus is not caused to access by an operating system.

7. The data delivery apparatus according to claim 1, wherein
the individual system is determined in accordance with at least one of a device driver to be built in a delivery destination apparatus, an application program to be installed in the delivery destination apparatus, and an operating system to be executed by the delivery destination apparatus, the delivery destination apparatus being one of the plurality of information processing apparatuses.

8. A non-transitory computer-readable recording medium storing a data delivery program causing a computer for delivering data to a plurality of information processing apparatuses to execute:
obtaining a master image which is a first image file generated from master data used in common for constructing different systems in the plurality of information processing apparatuses;
obtaining a difference image which is a second image file generated from difference data specifying details of modification to the master data to construct an individual system; and
delivering the master image and the difference image to the plurality of information processing apparatuses over a network.

9. The non-transitory computer-readable recording medium according to claim 8, the data delivery program further causing the computer to execute:
generating the master image by converting the master data to the first image file, the master data being stored in a storing section of an information processing apparatus other than the plurality of information processing apparatuses; and
generating the difference image by converting the difference data to the second image file, the difference data being generated from the master data and modified master data, the modified master data being generated by modifying the master data to construct the individual system.

10. The non-transitory computer-readable recording medium according to claim 8, the data delivery program further causing the computer to execute:
delivering a deployment program executable by each of the plurality of information processing apparatuses to the plurality of information processing apparatuses over the network before delivering the master image and the difference image, wherein
the deployment program is executed by a delivery destination apparatus and causes the delivery destination apparatus to determine whether the difference image is necessary for the delivery destination apparatus to construct the individual system, the delivery destination apparatus being one of the plurality of information processing apparatuses.

11. The non-transitory computer-readable recording medium according to claim 10, the data delivery program further causing the computer to execute:
delivering system specification data to the plurality of information processing apparatuses over the network before delivering the master image and the difference image, the system specification data specifying the individual system to be constructed in the delivery destination apparatus, wherein
the deployment program causes the delivery destination apparatus to make the determination based on the system specification data.

12. The non-transitory computer-readable recording medium according to claim 10, wherein
the deployment program causes the delivery destination apparatus to deploy the master image and the necessary difference image to construct the individual system in the delivery destination apparatus.

13. The non-transitory computer-readable recording medium according to claim 10, wherein
the deployment program causes the delivery destination apparatus to store the master image and the necessary difference image in an unused memory area of the delivery destination apparatus, the unused memory area being a memory area that the delivery destination apparatus is not caused to access by an operating system.

14. The non-transitory computer-readable recording medium according to claim 8, wherein
the individual system is determined in accordance with at least one of a device driver to be built in a delivery destination apparatus, an application program to be installed in the delivery destination apparatus, and an operating system to be executed by the delivery destination apparatus, the delivery destination apparatus being one of the plurality of information processing apparatuses.

15. A data delivery method executed by a data delivery apparatus for delivering data to a plurality of information processing apparatuses, the data delivery method comprising:
obtaining a master image which is a first image file generated from master data used in common for constructing different systems in the plurality of information processing apparatuses;
obtaining a difference image which is a second image file generated from difference data specifying details of modification to the master data to construct an individual system; and
delivering, by the data delivery apparatus, the master image and the difference image to the plurality of information processing apparatuses over a network.

16. The data delivery method according to claim 15, the data delivery method further comprising:
delivering a deployment program executable by each of the plurality of information processing apparatuses to the plurality of information processing apparatuses over the network before delivering the master image and the difference image, wherein
the deployment program is executed by a delivery destination apparatus and causes the delivery destination apparatus to determine whether the difference image is necessary for the delivery destination apparatus to construct the individual system, the delivery destination apparatus being one of the plurality of information processing apparatuses.

17. The data delivery method according to claim 16, the data delivery method further comprising:
delivering system specification data to the plurality of information processing apparatuses over the network before delivering the master image and the difference image, the system specification data specifying the individual system to be constructed in the delivery destination apparatus, wherein
the deployment program causes the delivery destination apparatus to make the determination based on the system specification data.

18. The data delivery method according to claim 16, wherein
the deployment program causes the delivery destination apparatus to deploy the master image and the necessary difference image to construct the individual system in the delivery destination apparatus.

19. The data delivery method according to claim 15, wherein
the individual system is determined in accordance with at least one of a device driver to be built in a delivery destination apparatus, an application program to be installed in the delivery destination apparatus, and an operating system to be executed by the delivery destination apparatus, the delivery destination apparatus being one of the plurality of information processing apparatuses.
